(19) United States
(12) Patent Application Publication
(10) Pub. No.: US 2016/0121936 A1
(43) Pub. Date: May 5, 2016

(54) Side Panel Assembly for Passenger Vehicles

(71) Applicants: THYSSENKRUPP STEEL EUROPE AG, Duisburg (DE); TECHNISCHE UNIVERSITÄT DRESDEN, Dresden (DE); LEICHTBAU-ZENTRUM SACHSEN GMBH, Dresden (DE)

(72) Inventors: Lothar Patberg, Moers (DE); Stefan Mayer, Schwerte (DE); Torsten Krahnert, Seddin (DE); Werner Hufenbach, Dresden (DE); Enrico Ladusch, Dresden (DE); Jens Werner, Coswig (DE); Andre Kiessling, Dresden (DE); Alexander Herbig, Dresden (DE); Jorn Kiele, Dresden (DE); Martin Lepper, Dresden (DE)

(21) Appl. No.: 14/897,826

(22) PCT Filed: May 2, 2014
(86) PCT No.: PCT/EP2014/059007

§ 371 Date: Dec. 11, 2015

(30) Foreign Application Priority Data
Jun. 12, 2013 (DE) 10 2013 106 070.6

(51) Int. Cl. B62D 25/02; B62D 29/00; B60R 13/08; B62D 25/04

(52) U.S. Cl. CPC B62D 25/02; B62D 25/04; B62D 29/004; B60R 13/0815

(57) ABSTRACT

A side panel assembly for a passenger vehicle, includes a B-pillar made of fibre-reinforced plastics material, at least one further pillar made of fibre-reinforced plastics material and following in the rear direction, and a side panel made of fibre-reinforced plastics material and defining a portion of the skin of the passenger vehicle. According to the invention, to make it possible for a side panel assembly of this kind to offer high stiffness for absorbing operating and crash loads while being low-weight, to have a high surface quality, and to be economical to produce with short production times, the B-pillar includes a hollow pillar made of metal as a core element.

The invention relates to a side panel assembly for a passenger vehicle, in particular an electric passenger vehicle, comprising a B-pillar made of fibre-reinforced plastics material, at least one further pillar made of fibre-reinforced plastics material and following in the rear direction, and a side panel made of fibre-reinforced plastics material and defining a portion of the skin of the passenger vehicle.

The automotive industry has tried, for a long time, to cost-effectively produce lighter vehicle body components which have comparable or improved mechanical properties. This development is based on the aim of achieving lower fuel consumption and/or reduced emissions of pollutants, in particular CO₂. Lighter body components which have good crash behaviour are very important, also in respect of electric vehicles, in particular when it is a case of improving the operating range and/or acceleration values of such vehicles.

Conventional car body components, such as a side wall panel assembly of a passenger compartment of a passenger vehicle, are composed of a plurality of individual parts. For example, A-, B-, C- and D-pillars, roof frames, skins and further components from a plurality of individual shells are joined by welding or adhesive bonding to form a side panel assembly. The side panel assembly is a partially supporting structure and must therefore also meet the requirements with regard to rigidity and crash behaviour, in particular with regard to a side impact and the vehicle rolling over. For this reason, currently support structures consisting of steel or aluminium are predominantly used for side panel assemblies. Conventional side panel assemblies are constructed from over 60 individual parts for example, and are joined by means of weld joints, rivet joints, adhesive joints and/or screwed joints in a plurality of production steps requiring a large amount of work. Furthermore, smaller side panel portions of side panel assemblies are also known, which are produced from plastics material. Said parts are typically produced in an SMC (sheet moulding compound) process. On account of the production method, said parts are manufactured as half-shell elements and are joined by adhesive bonding. In order to increase the rigidity and strength, said plastics material parts are additionally ribbed in the region of the shell cavity (cf. Karosserietechnik [Car body technology], Horst Pippert, Vogel Buchverlag, 1998, page 269). Such side panel portions have a relatively low level of lightweight design in terms of rigidity and strength on account of the undirected reinforcing fibres. In addition, on account of the shrinkage of the matrix material, they have an unsatisfactory appearance and usually require reworking prior to painting.

EP 1 052 164 A1 discloses a side panel assembly made of fibre-reinforced plastics material for passenger vehicles, which side panel assembly is produced as a moulded part in an RTM (resin transfer moulding) process, the fibre-reinforced plastics material having a fibre volumetric content of between 30% and 60%. In this case, the structurally supporting portions of the side panel assembly, in particular the B-pillars, are manufactured in a sandwich construction as hollow bodies which are filled in part or completely with a supporting core of foam, and the structurally non-supporting portions are manufactured in a cavity construction as hollow bodies. In order to produce a side panel assembly of this kind, textiles sheets are produced as preforms and inserted in an RTM mould form with the result that, in the region of the sandwich structures, one or more preforms envelop a foam core. In the region of the cavity structures, on the other hand, melting cores, which can be melted out, are inserted in the RTM mould form and enveloped by one or more preforms. After the mould form has been closed, a resin, for example an epoxy resin system, is injected into the mould, and once the injection procedure is complete the moulded part is cured. This known side panel assembly can be improved with regard to the rigidity and crash behaviour thereof and cost-effective manufacture.

The object of the present invention was that of providing a side panel assembly of the type mentioned at the outset, which has a low weight but a high degree of rigidity for absorbing operating and crash loads, an attractive surface quality, and can be produced in a cost-effective manner in short manufacturing times.

This object is achieved by a side panel assembly having the features of claim 1. Preferred and advantageous embodiments of the side panel assembly according to the invention form the subject matter of the dependent claims which are dependent on claim 1.

The side panel assembly according to the invention comprises a B-pillar made of fibre-reinforced plastics material, at least one further pillar made of fibre-reinforced plastics material and following in the rear direction, and a side panel made of fibre-reinforced plastics material and defining a portion of the skin of the passenger vehicle, wherein the B-pillar comprises a hollow pillar made of metall as a core element.

The B-pillar of the side panel assembly according to the invention is thus designed as a hybrid element comprising a hollow pillar made of metal, preferably steel, in particular tempered manganese-boron steel, or light metal, for example aluminium, magnesium or titanium, and a fibre-reinforced plastics material which encases the metallic hollow pillar. The hybrid B-pillar provides the side panel assembly according to the invention with a high degree of rigidity for absorbing operating and crash loads, while having a low weight. Preferably, the metallic hollow pillar of the hybrid B-pillar consists of partially tempered steel, a central longitudinal portion of the hollow pillar having a higher degree of tensile strength than the foot and/or the head of the hollow pillar. In particular, a seat belt can be optimally attached to the metallic hollow pillar in that the hollow pillar is provided, for example, with a threaded hole for a fastening screw. The integration (embedding) of an additional insertion element as a seat belt attachment element, as appears to be necessary in the side panel assembly known from EP 1 052 164 A1, is superfluous in the side panel assembly according to the invention. As a result, short manufacturing times and relatively low production costs can be achieved in addition. According to a first preferred embodiment, a further pillar of the side panel assembly according to the invention comprises a supporting core of plastics material, preferably foamed plastics material. In addition to the hybrid B-pillar, the further pillar made of fibre-reinforced plastics material, which has a supporting core made of a plastics material having a low density, preferably foamed plastics material, contributes to achieving a high degree of body rigidity for absorbing operating and crash loads, while still having a low component weight.

A preferred embodiment of the side panel assembly according to the invention is characterised in that the supporting core of the further pillar and/or the metallic hollow pillar of the B-pillar are each encased in a woven, layered or braided fabric formed of fibres (reinforcing fibres). As a result, the rigidity of the side panel assembly can be jointly optimised in various loading directions with a low component weight. Particularly preferably, the woven, layered or braided fabric is tubular and seamless. As a result, a high degree of component rigidity can be achieved using relatively little fibre material. Moreover, in this embodiment, an additional manufacturing step for producing a preform in the shape of a hollow channel from a two-dimensional braided or woven fabric can be omitted, as the tubular seamless woven or braided fabric already defines an optimal preform.

The fibres used for reinforcing the plastics material of the side panel assembly according to the invention are for example inorganic fibres, such as glass fibres, carbon or graphite fibres, ceramic fibres, metal fibres or metal wire, plastics fibres, natural fibres and/or mixed fibres formed thereof. Particularly preferably, glass fibres and/or carbon fibres are used as reinforcing fibres for producing the side panel assembly according to the invention.

The reinforcing fibres and/or the woven, layered or braided fabric formed thereof, are embedded in a matrix material made of a thermoplastic or thermosetting plastics material. This is carried out, for example, by means of an infiltration process, using a corresponding mould (infiltration mould). Correspondingly, according to a preferred embodiment of the side panel assembly according to the invention, the B-pillar, the at least one further pillar and the side panel are produced by means of an infiltration process. A device which processes thermoplastics, such as a thermoplastics press, can also be used. In this case, a hybrid yarn is preferably used in the reinforcing textiles, such as reinforcing fibres in the form of, preferably, carbon fibres in a thermoplastic matrix.

A further preferred embodiment of the side panel assembly according to the invention is characterised in that the B-pillar and the at least one further pillar are interconnected by the side panel. Side panel assemblies of this kind make it possible to produce the body of a passenger vehicle designed as a coupe, in particular a two-door sports car, in an advantageous manner.

The B-pillar and/or the at least one further pillar can be integrally bonded, for example adhesively bonded, to the side panel. In this case, the B-pillar and/or the at least one further pillar are integrally bonded or adhesively bonded to the side panel (skin), which is manufactured separately therefrom, in a subsequent processing step.

However, according to an alternative, particularly preferred embodiment of the side panel assembly according to the invention, the B-pillar and/or the at least one further pillar are integrally formed with the side panel. For this purpose, the metallic hollow pillar and/or the supporting core formed of plastics material, in particular foamed plastics material, are inserted, preferably each in a tubular braided or woven fibre sheathing, together with a textiles sheet or a braided fabric made of the above-mentioned reinforcing fibres, in a mould, in particular an infiltration mould, and are infiltrated, for example insert moulded, by fluid thermoplastic or thermosetting plastics material.

According to a further embodiment, already mentioned above, at least one fastening means for attaching a seat belt is directly connected to or formed on the metallic hollow pillar of the B-pillar (hybrid B-pillar), or can be integrally bonded to the metallic hollow pillar in a further processing step, for example by means of spot welding.

Furthermore, one or more attachment elements for attaching adjacent components, for example a roof frame part (roof longitudinal member) or roof crossmember, can be integrated in the side panel assembly according to the invention. In this case, the at least one attachment element or at least one of the attachment elements can be defined by or formed as an insertion element. In this case, the insertion element constitutes a node element and is preferably formed as an injection moulded part, in particular as a cast aluminium construction. The node element is connected to the hybrid B-pillar for example.

In a further embodiment of the side panel assembly according to the invention, it is provided for a longitudinal portion of the B-pillar and/or a longitudinal portion of the at least one further pillar to protrude with respect to the bottom edge of the side panel. The protruding longitudinal portion of the B-pillar and/or further pillar can thus advantageously be used as an attachment point for an adjacent body part, for example a door sill, a rear valance or a rear bumper.

According to a further preferred embodiment of the side panel assembly according to the invention, the side panel thereof comprises a plurality of functional surfaces which are integrally formed therewith and are arranged so as to be set back with respect to a tangential plane adjoining the outside thereof. These functional surfaces are a lamp pod, the sealing surface of the vehicle door, the attachment surface for a door locking part, the sealing surface of a side window pane and/or the sealing surface of a tailgate for example.

A further advantageous embodiment of the side panel assembly according to the invention is characterised in that the side panel is designed in a sandwich construction. Moreover, said side panel can comprise at least one sound absorbing surface element which is integrated in the cross section thereof or attached to the inside thereof.

In the following, the invention will be described in further detail on the basis of drawings showing a plurality of embodiments. In the schematic drawings:

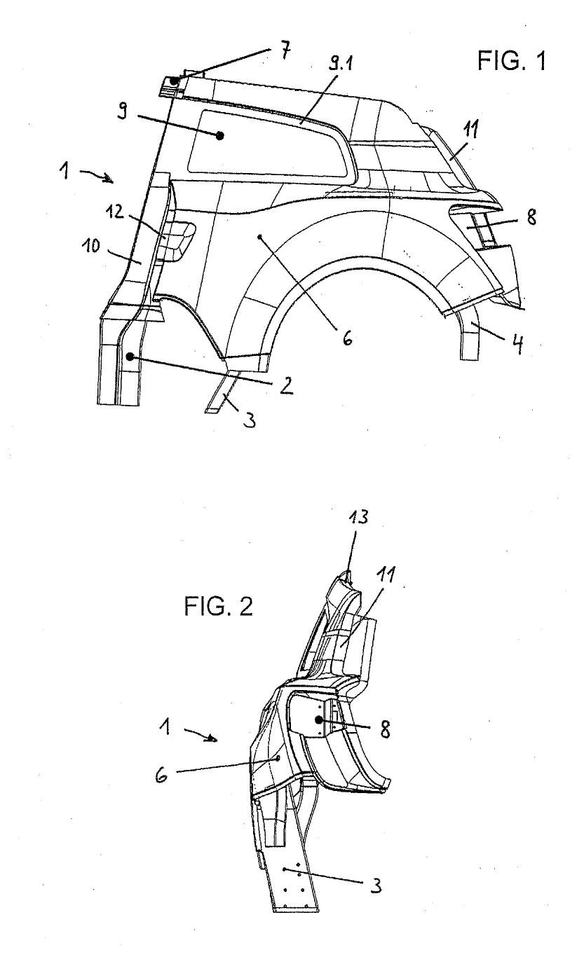

FIG. 1 is a side view (outside view) of a side panel assembly according to the invention;

FIG. 2 is a rear view of the side panel assembly from FIG. 1;

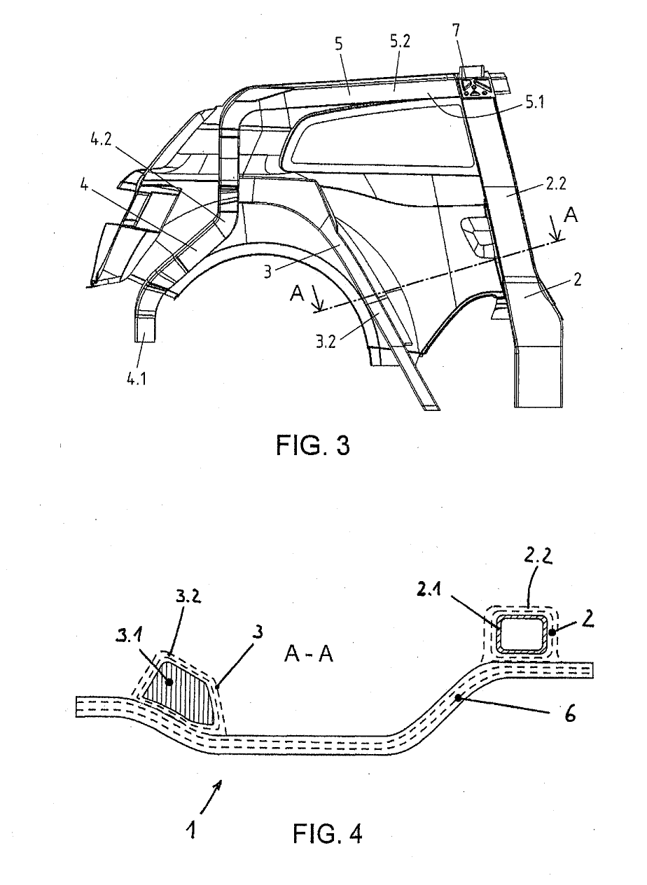

FIG. 3 is an inside view of the side panel assembly from FIG. 1;

FIG. 4 is a simplified, enlarged cross section along the section line A-A in FIG. 3;

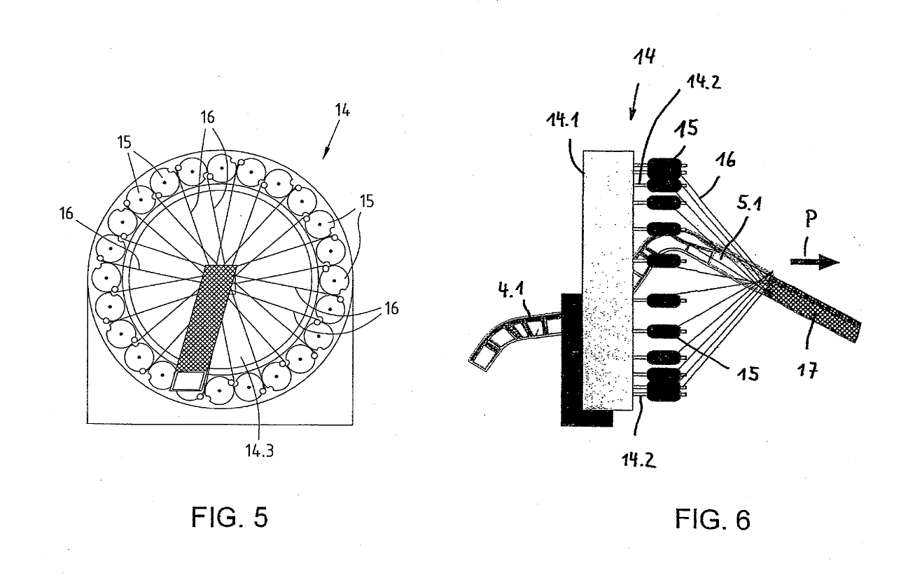

FIG. 5 and FIG. 6 are a front view and a side view respectively of a device for encasing a supporting core or a metallic hollow support (hollow pillar) in reinforcing fibres;

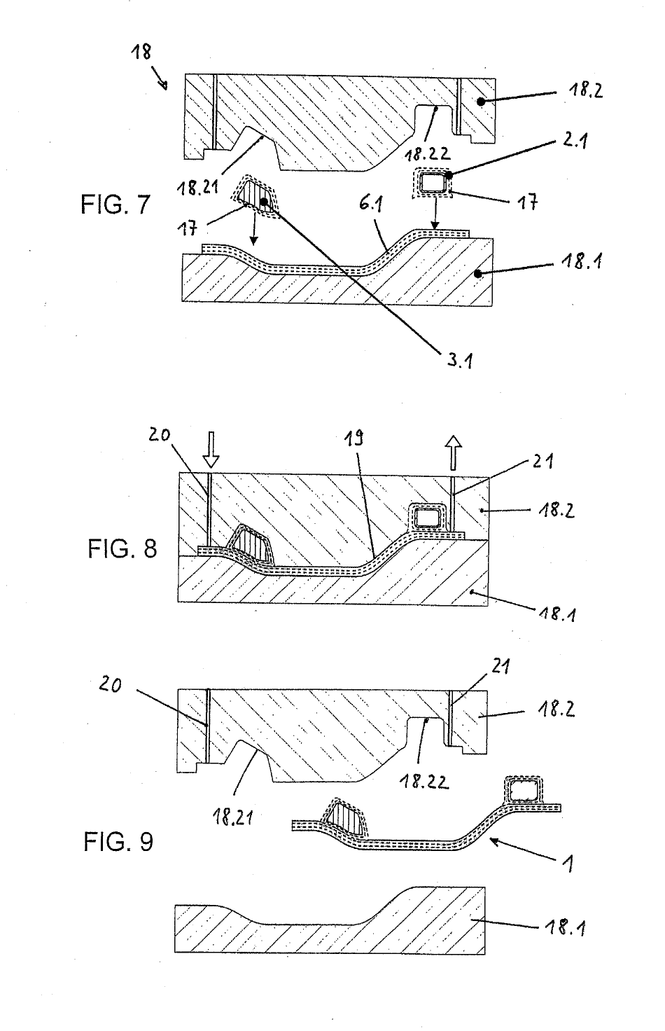

FIG. 7 is a sectional view of an infiltration mould for producing a side panel assembly according to the invention, in which the mould is open and loaded with a textiles sheet made of reinforcing fibres, a columnar supporting core made of plastics materials and encased in reinforcing fibres, and a columnar metallic hollow support encased in reinforcing fibres;

FIG. 8 shows the infiltration mould according to FIG. 7 in the closed state during the infiltration process; and

FIG. 9 shows the infiltration mould according to FIG. 7 in the open state, in which the finished side panel assembly is being removed from the mould.

The side panel assembly 1 shown in FIGS. 1 to 4 is constructed from a B-pillar 2, a C-pillar 3, a D-pillar 4, a roof longitudinal member 5 and a skin shell defining a side panel 6. The pillars 2-4, the roof longitudinal member 5 and the side panel (skin shell) 6 are each produced from fibre-reinforced plastics material, wherein the B-pillar 2 contains a hollow pillar 2.1 made of metal which is encased in fibre-reinforced plastics material. The B-pillar 2 can therefore also be referred to as a hybrid B-pillar. The hollow pillar 2.1 is manufactured for example from a light metal, in particular aluminium, or steel, preferably partially tempered steel. At least one of the further pillars, in particular the C-pillar 3, or preferably also the D-pillar 4 and/or the roof longitudinal member 5 comprise a pillar-like supporting core, 3.1, 4.1 and 5.1 respectively, made of low-density plastics material. The respective supporting core 3.1, 4.1, 5.1 preferably consists of foamed plastics material, for example of closed-cell rigid foam or structural foam. The supporting core 3.1, 4.1, 5.1 is coated with at least one layer 3.2, 4.2, 5.2 made of a fibre-reinforced plastics material. Likewise, the metallic hollow pillar 2.1 is also coated with at least one layer 2.2 made of a fibre-reinforced plastics material.

The reinforcing fibres, which are preferably glass fibres and/or carbon fibres, are present in the form of a textile. The textile is formed as a braided, layered or woven fabric and embedded in the matrix formed of thermoplastic or thermosetting plastics material. The fibre-reinforced or textile-reinforced plastics layer 2.2, 3.2, 4.2 or 5.2 has a layer thickness of approximately 4 mm for example.

The side panel (skin shell) 6 likewise contains a textile made of reinforcing fibres, preferably glass fibres and/or carbon fibres. The textile is formed as a woven, layered or braided or non-woven fabric for example, and is in turn embedded in a matrix made of a thermoplastic or thermosetting plastics material. The fibre-reinforced or textile-reinforced side panel 6 has a thickness of approximately 1 mm for example.

The fibre reinforcement of the side panel 6, hybrid B-pillar 2 and the other pillars/supports 3, 4, 5 is composed in each case of one or more layers of the textile mentioned. The plastics material of the side panel 6, hybrid B-pillar 2 and the other pillars/supports 3, 4, 5, which plastics material contains the textile, is preferably integrally formed. The side panel assembly 1 is thus an integral body component.

One or more attachment elements for attaching adjacent components are integrated in the side panel assembly 1. For example, the side panel assembly 1 comprises a node element (attachment element) 7 for attaching a roof crossmember (not shown). The node element 7 is preferably formed as a cast aluminium part and integrally bonded to the hybrid B-pillar 2 for example.

Moreover, the side panel assembly 1 comprises a plurality of integral functional surfaces which are moulded into the side panel (skin shell) 6. The functional surfaces are preferably arranged so as to be set back with respect to a tangential plane adjoining the outside of the side panel (skin shell) 6. The functional surfaces integrated in the side panel assembly 1 for example define a lamp pod 8, a peripheral sealing surface or bonding surface 9.1 for a side pane at a window opening 9, a sealing surface 10, 11 for a vehicle door or a tailgate, an attachment surface 12 for a door locking element, for example a door safety catch, and/or receiving surfaces 13 for adjacent body components, e.g. a roof panel shell, a door sill or a rear bumper fascia. It can be seen in particular in FIGS. 1 and 3 that lower longitudinal portions of the hybrid B-pillar 2 and the C-pillar 3 and the D-pillar 4 protrude with respect to the bottom edge of the side panel 6.

The side panel assembly 1 shown in FIGS. 1 to 4 can be produced in one process step by means of an infiltration process.

FIGS. 5 and 6 show a device 14 in the form of what is known as a braiding wheel for encasing a supporting core 3.1, 4.1, 5.1 or a metallic hollow support (hollow pillar) 2.1 in reinforcing fibres. For this purpose, the reinforcing fibres, preferably glass fibres and/or carbon fibres, are provided in the form of rovings or filaments 16 wound onto bobbins 15. The device comprises a driven slewing ring 14.1 having a plurality of pins (spindles) 14.2 on which the bobbins 15 are rotatably held. The supporting core 4.1, 5.1 (or 3.1 or metallic hollow support 2.1) to be encased is moved in the direction of the arrow P through the through-opening 14.3 defined by the slewing ring 14.1, at the same time the slewing ring 14.1 being rotated together with the bobbins 15 rotatably held thereon. In this way, the supporting core 4.1, 5.1 (3.1 or metallic hollow support 2.1) is encased in a tubular braided or woven fabric 17. The tubular woven or braided fabric 17 thus produced is formed so as to be seamless. It can be seen in FIG. 6 that reinforcing fibres (reinforcing filaments 16) are braided over a supporting core 5.1, 4.1 produced from foam, which core substantially has the shape of the D-pillar 4 and the roof longitudinal member 5 of the side panel assembly shown in FIGS. 1 to 4. In a corresponding manner, reinforcing fibres (reinforcing filaments 16) are also braided over the supporting core (foam core) 3.1 for the C-pillar 3 and the metallic hollow pillar 2.1 for the hybrid B-pillar 2.

Subsequently, the supporting cores/supports 3.1, 4.1, 5.1 encased by the respective reinforcing fibre braided fabrics 17, and the correspondingly encased metallic hollow pillar 2.1 are inserted in an infiltration mould together with at least one layer of a textile preform or textiles sheet 6.1 made of reinforcing fibres (see FIG. 7). Optionally, one or more further attachment parts can be inserted in the infiltration mould 18 as insertion elements, e.g. a node element 7 for attaching a roof crossmember. The infiltration mould 18 comprises at least one lower mould 18.1 and at least one upper mould 18.2 which, in the closed state of the infiltration mould 18, define a cavity 19 which substantially corresponds to the shape of the side panel assembly 1 to be produced.

In the embodiment shown in FIGS. 7 to 9, recesses 18.21, 18.22 are formed in the mould face of the upper mould 18.2, which receive the hollow pillar 2.1 encased in braided fibre for the hybrid B-pillar and the supporting core (foam core) 3.1 encased in braided fabric for the C-pillar respectively. In addition, the upper mould 18.2 comprises recesses (not shown) for receiving the supporting core (foam core) 4.1, 5.1 encased in braided fabric for the D-pillar 4 and the roof longitudinal member 5. Furthermore, one or more plastics material feed channels 20 opening into the cavity 19 and at least one air vent 21 connected to the cavity are provided. A vacuum can be placed over the air vent 21 in the cavity 19, which vacuum promotes the infiltration of the textiles sheet 6.1 and of the tubular braided fabric 17 by the initially fluid matrix material (thermoplastic or thermosetting plastics material). Moreover, the infiltration mould is provided with a tempering device (not shown) for causing or accelerating the curing of the plastics material injected in the cavity. Once the plastics material has been cured sufficiently, the infiltration mould is opened and the finished side panel assembly removed (see FIG. 9).

The configuration of the side panel assembly according to the invention is not restricted to the embodiments shown in the drawings. Rather, a number of variants are conceivable, which make use of the invention specified in the accompanying claims, even in a form which differs from the drawings. Thus, for example, the support structure composed of the hybrid B-pillar 2 and the at least one further pillar 3 can be adhesively bonded to the side panel (skin) 6 in a subsequent work step.

1. A side panel assembly for a passenger vehicle, comprising a B-pillar made of fibre-reinforced plastics material, at least one further pillar made of fibre-reinforced plastics material and following in the rear direction, and a side panel made of fibre-reinforced plastics material and defining a portion of the skin of the passenger vehicle, wherein the B-pillar comprises a hollow pillar made of metal as a core element.

2. The side panel assembly according to claim 1, wherein the at least one further pillar comprises a supporting core made of foamed plastics material.

3. The side panel assembly according to claim 2, wherein the supporting core is encased in a woven, layered or braided fabric formed of fibres.

4. The side panel assembly according to claim 1, wherein the metallic hollow pillar of the B-pillar is encased in a woven, layered or braided fabric formed of fibres.

5. The side panel assembly according to claim 4, wherein the woven or braided fabric is tubular and seamless.

6. The side panel assembly according to claim 1, wherein the B-pillar and the at least one further pillar are interconnected by the side panel.

7. The side panel assembly according to claim 1, wherein the B-pillar and/or the at least one further pillar are integrally bonded to the side panel.

8. The side panel assembly according to claim 1, wherein the B-pillar and/or the at least one further pillar are integrally formed with the side panel.

9. The side panel assembly according to claim 1, wherein at least one fastening means for attaching a seat belt is directly connected to or formed on the metallic hollow pillar of the B-pillar.

10. The side panel assembly according to claim 1, wherein one or more attachment elements for attaching adjacent components are integrated therein.

11. The side panel assembly according to claim 10, wherein the at least one attachment element or at least one of the attachment elements is defined by an insertion element.

12. The side panel assembly according to claim 1, wherein the side panel comprises a plurality of functional surfaces integrally formed therewith, which surfaces are arranged so as to be set back with respect to a tangential plane adjoining the outside thereof.

13. The side panel assembly according to claim 1, wherein the side panel comprises at least one sound absorbing surface element which is integrated in the cross section thereof or attached to the inside thereof.

14. The side panel assembly according to claim 1, wherein the B-pillar, the at least one further pillar and the side panel are produced by means of an infiltration process.

15. The side panel assembly according to claim 1, wherein a longitudinal portion of the B-pillar and/or a longitudinal portion of the at least one further pillar protrude with respect to the bottom edge of the side panel.
